(19) United States
(12) Patent Application Publication
(10) Pub. No.: US 2007/0292825 A1
(43) Pub. Date: Dec. 20, 2007

(54) Simulative form audio player

(76) Inventors: Sun Yu, Berkley, MI (US); David Perrin, Warren, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/443,982

(22) Filed: May 31, 2006

(51) Int. Cl. G09B 19/00

(52) U.S. Cl. 434/156

(57) ABSTRACT

An audio player is provided that includes a sound storage memory and a speaker with at least a portion of each of the memory and the speaker contained within a housing in an animate form and having a movable portion. A playback button extends from the housing retrieving a sound from the memory as an output from the speaker. The playback button also induces movement of the movable portion of the housing. An ink reservoir terminating in a writing tip and a microphone with an associated recording button extending from the housing and mechanically activating the microphone to store sound in the memory are each provided alone or in combination within the audio player. An audio player housing in a simulative form of a bird contains an ink reservoir within the tail portion of the bird while the auditory playback and optional recording is provided via a housing portion simulative of a beak.

### FIELD OF THE INVENTION

The present invention in general relates to an audio player with an optional recorder function and in particular to an audio player with a recorder function having a simulative form.

### BACKGROUND OF THE INVENTION

In a highly mobile society, there is often a need to scribe notes. The subject matter of such notes might for instance include a task to be performed, a phone number, directions, or a shopping list. Unfortunately, a writing implement and paper are routinely unavailable in instances when an individual is driving or away from a desk.

A solution for the recordation of a note absent a pencil and paper is a tape recorder. While considerable strides have been made in miniaturizing a tape recorder to the point where it is a practical, everyday portable device, the cost and complexity of such recorders has limited the acceptance of such recorders. Additionally, miniaturization of tape recorders to allow for everyday usage has necessarily decreased the size of activation buttons and the requirement to read small font size print associated with function keys. Use of such function keys and reading of explanatory text associated with the recorder tends to make such devices awkward for children and the elderly to operate.

Thus, there exists a need for a miniaturized tape recorder having a simulative form that is intuitive to use and easily operated.

### SUMMARY OF THE INVENTION

An audio player is provided that includes a sound storage memory and a speaker with at least a portion of each of the memory and the speaker contained within a housing in an animate form and having a movable portion. A playback button extends from the housing and upon activation retrieves a sound from the memory as an output from the speaker. The playback button also induces movement of the movable portion of the housing. An ink reservoir terminating in a writing tip and a microphone with an associated recording button extending from the housing and mechanically activating the microphone to store sound in the memory are each provided alone or in combination within the audio player. An audio player housing in a simulative form of a bird contains an ink reservoir within the tail portion of the bird while the auditory playback and optional recording is provided via a housing portion simulative of a beak.

An audio player is also provided that includes a sound storage memory in a speaker contained within a housing in an animate form and having a moveable portion with an aperture provided for engaging a keychain ring directly or via an intermediate swivel. A playback button extending from the housing retrieves the sound from the memory as an output from the speaker. The playback button activation also induces movement of a moveable portion of the housing; typically the moveable housing portion is the head and/or mouth portion of an animate form housing. A light suitable for facilitating the convergence between a key attached to the housing and a suitable lock is provided along with an audio output from the memory.

### BRIEF DESCRIPTION OF THE DRAWINGS

FIG. 1 is a perspective view of an inventive audio player embodiment including an audio recorder and an ink reservoir terminating in a writing tip with a movable portion in an extended position;

FIG. 2 is a longitudinal cross-sectional view of the player detailed in FIG. 1 with a movable portion in a closed position;

FIG. 3A is a side view of an inventive player operative as a keychain with a movable head portion; and

FIG. 3B is a longitudinal opposite cross-sectional view of the player having a keychain depicted in FIG. 3A.

### DETAILED DESCRIPTION OF THE PREFERRED EMBODIMENTS

The present invention has utility in its simplest form as an amusement that plays sounds and moves in response to activation of a playback button. Inventive embodiments that include an audio recorder, an ink reservoir terminating in a writing tip, a keychain, or a combination thereof have added utility based on these functions with the combination device being particularly well suited for collecting and transcribing an audio signal. An inventive audio player has a simulative form housing with a portion of the housing moving in response to activation of the playback button that initiates audio play. This movement alone or in combination with a light signal makes it less likely that a user will confuse record and playback modes of an inventive player.

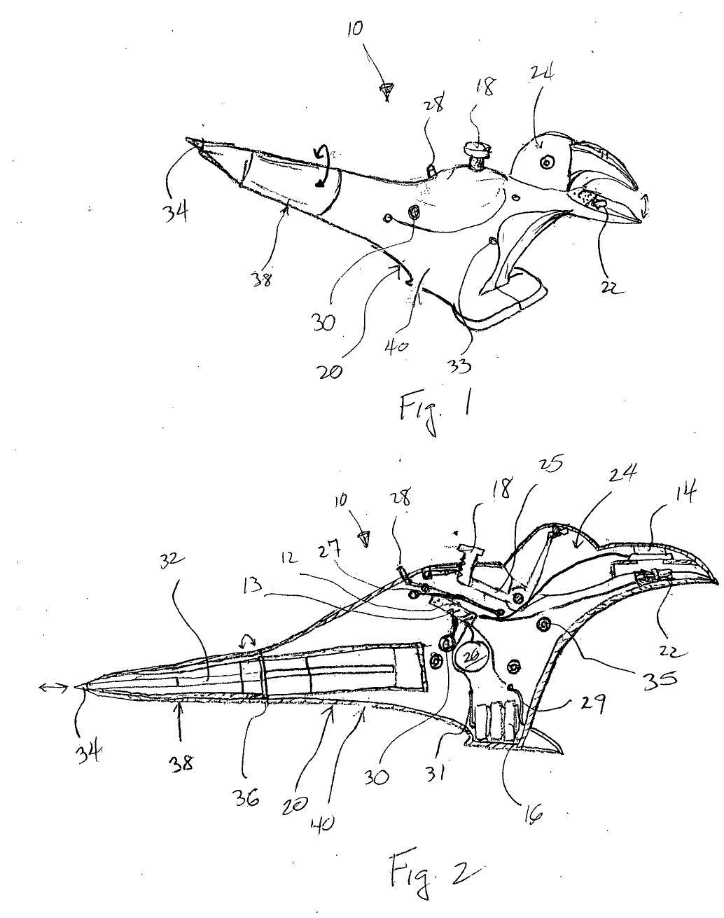

Referring now to FIGS. 1 and 2, an inventive audio player is shown generally at 10. The player 10 has a digital sound storage memory 12 on a printed circuit board 13 coupled to a speaker 14. A battery 16 is provided to form an electrical circuit between the memory 12 and speaker 14 such that an inventive player 10 emits a stored sound in response to activation of a playback button 18. Playback button 18 extends from the stationary portion 40 of the player housing 20.

The player housing 20 is in a simulative form. The housing 20 is typically formed from cast metal, thermoplastic or thermoset resin. The housing 20 is also amenable to receiving printed or painted indicia or markings so as to further enhance the simulative nature of the housing 20. While an inventive housing 20 is readily formed in a variety of simulative forms such as those of a building, vehicle, geometric form, ergonomic form or animate form, preferably the housing 20 is in an animate form of an animal. While the present invention is detailed herein with respect to an animate form housing 20 in the shape of a toucan, it is appreciated that any number of simulative forms are operative within the present invention.

Preferably, the playback button 18 extends from the simulative housing 20 in a region corresponding to the body of the toucan. “Fast forward” and/or reverse controls are also optionally provided (not shown). Optionally, an indicator light 22 is activated upon engagement of the playback button 18. The light 22, if present, is preferably a light emitting diode (LED). While the light 22 is appreciated to be amenable to placement anywhere within the housing 20 to provide a visual indication that the player 10 is in playback mode, preferably the light 22 is emitted from the mouth of the simulative toucan housing. The movement of the movable portion 24 is a result of a mechanical transmission of force from the depressed playback button 18 to a lever 25 mechanically coupled to the movable portion 24. Optionally, a click plate 37 affixed to the housing 20 engages the lever 25 to retain the movable portion 24 in an open position absent finger press of the button 18. Alternatively, the movable portion 24 is moved by an electrical motor powered by the battery 16 and coupled to the movable portion 24 by gearing (not shown). In operation, upon the playback button 18 being depressed, a switch plate 27 is contacted that in turn completes an electrical circuit between the battery 16 (via contacts 29 and 31), the memory 12 and the speaker 14 so as to emit a stored sound from the speaker 14. In addition, the playback button 18 initiates movement of movable portion 24 of the housing 20 upon engagement and optionally also completes an electrical circuit between the battery and indicator light 22 to provide a visual signal that the inventive player 10 is in playback mode.

Optionally, the audio player 10 also includes a microphone 26. The microphone 26 resides within the housing 20 and selectively forms an electrical circuit with the battery 16 upon depression of a recording button 28 extending from the housing 20. As depicted in FIGS. 1 and 2, the recording button 28 is preferably located on the body of toucan simulative housing 20. Upon depressing the recording button 28, an inventive player 10 is placed in a recording mode thereby activating the microphone 26 to store a sound to the digital sound storage memory 12. Optionally, a recording indicator light 30 is also provided to emit light from the housing 20. The light 30, if present, in combination with playback indicator light 22 is preferably of a different color than the playback indicator light 22 so as to visually differentiate whether the player 10 is in playback or recording mode. Preferably, a recorder indicator light 30 is an LED. An attachment such as a key ring, a spring-biased clip, or lanyard is optional attached to the housing 20 for the securement of various personal articles such as keys, a miniature flashlight or the like.

An inventive player 10 also includes an ink reservoir 32 terminating in a writing tip 34. The ink reservoir 32 can be incorporated into the housing 20 by press fitting the reservoir 32 into a complementary bore in the housing 20. Preferably, the ink reservoir 32 is movable relative to the housing 20 between a storage position in which the writing tip 32 is contained within the housing 20 and a writing position in which the writing tip 34 extends therefrom. Numerous retraction mechanisms are known to the art for moving a pen tip between two positions. Preferably, the retraction mechanism is a swivel 36 rotating a portion 38 of the housing 20 relative to the stationary portion 40 of the housing 20. As depicted in the accompanying figures, the ink reservoir 32 is located within a housing portion 38 representative of a toucan tail. In this position, the tail portion 38 of the housing 20 is rotated to facilitate writing while the playback button 18 and recording button 28 remain accessible on the remainder 40 of the housing 20. Additionally, in this configuration a user hand writing beneath the user head orients the beak movable portion 24 and lights 22 and/or 30 so as to be visible to the user while writing. This arrangement is appreciated to greatly facilitate transcription of a sound stored within the memory 12.

The housing 20 is readily closed to protect components therein with conventional fastening techniques such as sonic welding, pressure adhesives and mechanical fasteners. It is appreciated that threaded mechanical fasteners 33 engaging complementary threads 35 to close the housing 20 are amenable to removal to replace a spent battery 16 or other internal components. The voltage characteristics of the battery 16 are appreciated to be dictated by the electrical operating parameters of player components such as the memory 12, speaker 14 and microphone 26 as well as the optional lights 22 and 30. A preferred battery 16 is actually three button cell alkali batteries so as to increase operating voltage and provide a compact profile. It is appreciated that other battery configurations and compositions are also operative herein.

In an alternate embodiment, no provision is made for the collection and storage of sound; rather, the sound storage memory 12 of printed circuit board 13 is preloaded with a programmed sound or collection of sounds to be played back upon depression of the playback button 18. Such sounds are, for instance, simulative of sounds made by the object or creature simulated by the housing 20.

Referring now to FIG. 3, an inventive audio player is shown generally at 100 where like numerals correspond to those referenced with respect to FIGS. 1 and 2. The player 100 has a digital sound storage memory 12 and a printed circuit board 13 coupled to a speaker 14. A battery 16 is provided to form an electrical circuit between the memory 12 and speaker 14 such that the inventive player 100 emits a stored sound in response to activation of a playback button 18. The playback button 18 is activated in the player 100 by rotating the dog head 102 into an open configuration.

The player housing 106 is in a simulative form of a sitting dog. The housing 104 is typically formed from cast metal, thermoplastic or thermoset resin. The housing 104 is also amenable to receiving printed or painted indicia or markings as to further enhance the simulative nature of the housing 104. While the housing 104 is readily formed in a variety of simulative forms, such as those of a building, a vehicle, geometric form, ergonomic form or animate form, preferably the housing 104 is in an animate form of an animal. Coupled to the head portion 102 of the housing 104 is a lever 106 having an aperture 108 therethrough. The aperture 108 is amenable to receiving a swivel (not shown) amenable to in turn receiving a keychain ring or alternatively, the aperture 108 directly receives a keychain ring. An access plate 110 is provided in the housing 104 to selectively provide access to the battery 16 housed therein. The access panel 110 is held in place with a mechanical fastener 112. Upon the head portion being tilted to activate playback button 18, an indicator light 22 is activated. The light 22 is preferably an LED. While the light 22 is appreciated to be amenable to placement anywhere within the housing 104 to provide visual indication that the player 100 is in playback mode, preferably the light 22 is emitted from the moveable portion that is fashioned as the mouth of the animate form which, as depicted, is a sitting dog. In this way, a light useful to locate a lock is found within inventive player 100 complementary to a key engaging a key ring 114.

It is appreciated that an aperture suitable for engaging a key ring 114 is readily formed in other portions of the housing 104, such as an immoveable portion relative to head portion 102.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. An audio player comprising:
a microphone;
a sound storage memory;
a speaker;
a housing in a simulative form having a movable portion, said housing enclosing at least a portion of each of said microphone, said memory, and said speaker;
a recording button exposed through said housing and activating said microphone to store a sound in said memory;
a playback button exposed through said housing retrieving the sound from said memory as an output from said speaker, said playback button also inducing movement of the movable portion of said housing; and
a battery selectively powering said memory and one of said microphone or said speaker in response to said recording button or said playback button, respectively, being activated.

2. The player of claim 1 further comprising an ink reservoir terminating in a writing tip incorporated within said housing.

3. The player of claim 2 further comprising a retraction mechanism within said housing for moving said writing tip between a writing position and a storage position.

4. The player of claim 3 wherein said retraction mechanism is a swivel rotating a portion of said housing containing said ink reservoir.

5. The player of claim 1 further comprising a recording indicator light activated upon engagement of said recording button.

6. The player of claim 5 wherein said light indicator is a light emitting diode.

7. The player of claim 1 further comprising a playback indicator light activated upon engagement of said playback button.

8. The player of claim 1 wherein the animate form of said housing is a bird and the movable portion is a bird beak.

9. The player of claim 8 further comprising a writing tip extending within a tail portion of said bird form housing.

10. The player of claim 1 further comprising an attachment selected from the group consisting of: a key ring, a spring-biased clip, or lanyard.

11. An audio player comprising:
a microphone;
a sound storage memory;
a speaker;
a housing simulative of an animate form and having a movable portion corresponding to the mouth of the animate form;
a recording button exposed through said housing and activating said microphone to store a sound in said memory;
a playback button exposed through said housing retrieving the sound from said memory as an output from said speaker, said playback button also inducing movement of the mouth portion of said housing;
an ink reservoir terminating in a writing tip within said housing; and
a battery selectively powering said memory and one of said microphone or said speaker in response to said recording button or said playback button, respectively, being activated.

12. The player of claim 11 further comprising a retraction mechanism within said housing for moving said writing tip between a writing position and a storage position.

13. The player of claim 12 wherein said retraction mechanism is a swivel rotating a portion of said housing containing said ink reservoir.

14. The player of claim 11 further comprising an indicator light activated upon engagement of said recording button.

15. The player of claim 11 further comprising a playback indicator light activated upon activation of said playback button.

16. An audio player comprising:
a sound storage memory;
a speaker;
an ink reservoir terminating in a writing tip;
a housing in an animate form having a movable portion, said housing enclosing at least a portion of each of said memory, said speaker, and said ink reservoir;
a playback button exposed through said housing retrieving the sound from said memory as an output from said speaker, said playback button also inducing movement of the movable portion of said housing; and
a battery selectively powering said memory and said speaker in response to said playback button being activated.

17. The player of claim 16 further comprising a retraction mechanism within said housing for moving said writing tip between a writing position and a storage position.

18. The player of claim 17 wherein said retraction mechanism is a swivel rotating a portion of said housing containing said ink reservoir.

19. The player of claim 16 further comprising a playback indicator light activated upon engagement of said playback button.

20. The player of claim 16 wherein the animate form of said housing is a bird and the movable portion is a bird beak.

21. The player of claim 20 further comprising a writing tip extending within a tail portion of said bird form housing.

22. An audio player comprising:
a sound storage memory;
a speaker;
a housing in an animate form having a movable portion, said housing enclosing at least a portion of each of said memory, and said speaker;
a playback button exposed through said housing retrieving the sound from said memory as an output from said speaker, said playback button also inducing movement of the movable portion of said housing;
a battery selectively powering said memory and said speaker in response to said playback button being activated; and
an attachment coupled to said housing, said attachment selected from the group consisting of: a key ring, a spring-biased clip, or lanyard.

23. The player of claim 22 further comprising a playback indicator light activated upon engagement of said playback button.

24. The player of claim 22 wherein the movable portion is fashioned as a mouth of the animate form.
